(19) United States
(12) Patent Application Publication
(10) Pub. No.: US 2016/0261678 A1
(43) Pub. Date: Sep. 8, 2016

(54) FILE TRANSFER METHOD AND APPARATUS

(71) Applicant: HUAWEI DEVICE CO., LTD., Shenzhen (CN)

(72) Inventors: Ji CHEN, Shenzhen (CN); Zhiming Ding, Shenzhen (CN); Zhenguo Du, Shenzhen (CN); Ping Fang, Shenzhen (CN)

(73) Assignee: HUAWEI DEVICE CO., LTD., Shenzhen (CN)

(21) Appl. No.: 15/152,957

(22) Filed: May 12, 2016

Related U.S. Application Data
(63) Continuation of application No. PCT/CN2014/091261, filed on Nov. 17, 2014.

(30) Foreign Application Priority Data
Nov. 15, 2013 (CN) 201310573873.7

(51) Int. Cl. H04L 29/08; H04L 29/12

(52) U.S. Cl. CPC H04L 67/06; H04L 67/1044; H04L 67/1051; H04L 61/2015; H04L 61/2069

(57) ABSTRACT

A file transfer method includes: sending, by a sending device, a ready request message to a multicast group in a multicast manner; when receiving a first ready message returned by a first device in the multicast group, sending, by the sending device, a master receiving device determining message to the first device, where the master receiving device determining message is used to notify the first device that the first device has been selected as a master receiving device, and sending a data packet of a to-be-sent file to the multicast group in a multicast manner; and when a second device newly joins the multicast group, sending a first message to the second device to notify it in time of information about a file that is currently being transferred, so that the newly joined device can start receiving immediately.

### CROSS-REFERENCE TO RELATED APPLICATIONS

This application is a continuation of International Application No. PCT/CN2014/091261, filed on Nov. 17, 2014, which claims priority to Chinese Patent Application No. 201310573873.7, filed on Nov. 15, 2013, both of which are hereby incorporated by reference in their entireties.

### TECHNICAL FIELD

The present invention relates to the field of communications technologies, and in particular, to a file transfer method and apparatus.

### BACKGROUND

WiFi (Wireless Fidelity, Wireless Fidelity) is a wireless network communications technology that connects terminals such as a personal computer and a handheld device (for example, a PDA (Personal Digital Assistant, personal digital assistant) and a mobile phone) to each other in a wireless manner, which improves interoperability between wireless network products that are based on the IEEE802.11 standard.

An existing WiFi technology provides MFTP (Multicast File Transfer Protocol, Multicast File Transfer Protocol) used to implement one-to-many multicast. A function of MFTP is to transfer a file from one device to multiple devices. Under a precondition that a multicast group has been established, a transfer process of the multicast group is described briefly as follows: A sending device divides a file into several data packets of a specified length, and the sending device sends an RRQ (Ready Request, ready request message) to the multicast group in a multicast manner. After receiving the RRQ, a receiving device in the multicast group sends an RDY (Ready, ready message) to the sending device, and the sending device selects a receiving device that first returns the RDY as a master receiving device (master receiver). The sending device sends file content to all receiving devices in a multicast manner. In a multicast process, only the master receiving device needs to return an ACK (Acknowledgment, acknowledgment message) to the sending device, and each time the sending device receives an ACK returned by the master receiving device, the sending device continues to send a next data packet in a multicast manner. After a current master receiving device completes receiving of the file content, the foregoing method for selecting a master receiving device is repeated, and a next master receiving device is selected from receiving devices that have not completed the receiving, so as to continue to send a data packet in a multicast manner until all receiving devices complete the receiving.

In a process of implementing the present invention, the prior art has at least the following disadvantages:

In a one-to-many multicast scenario, a receiving device can start to receive multicast content only after replying to an RRQ broadcast by a sending device. However, once some receiving devices (for example, devices that newly join the multicast group) miss an RRQ broadcast by the sending device when transfer starts, the receiving devices cannot start to receive multicast content in time, thereby reducing transfer efficiency.

### SUMMARY

To resolve a problem of low transfer efficiency, embodiments of the present invention provide a file transfer method and apparatus. Technical solutions are as follows:

According to a first aspect, a file transfer method is provided, where the method includes:

sending, by a sending device, a ready request message to a multicast group in a multicast manner, where the ready request message carries at least a file name and block quantity of a to-be-sent file, and the multicast group includes at least one device;

when receiving a first ready message returned by a first device in the multicast group, sending, by the sending device, a first master receiving device determining message to the first device, where the first master receiving device determining message is used to notify the first device that the first device has been selected as a master receiving device, and sending a data packet of the to-be-sent file to the multicast group in a multicast manner; and

sending a first message to a second device when the second device newly joins the multicast group, where the first message carries at least the file name and block quantity of the to-be-sent file and a first data packet identifier, the first data packet identifier is used to indicate a data packet to be transferred by the sending device, and the first message is used to notify the second device of information about the data packet to be transferred by the sending device, so that the second device receives, according to the first message, the data packet that is of the to-be-sent file and is to be transferred by the sending device.

With reference to the first aspect, in a first possible implementation manner of the first aspect, after the sending a first message to a second device when the second device newly joins the multicast group, the method further includes:

receiving a ready message sent by the second device.

With reference to the first aspect, in a second possible implementation manner of the first aspect, after the sending a first message to a second device, so that the second device receives, according to the first message, the data packet that is of the to-be-sent file and is to be transferred by the sending device, and when the current master receiving device of the multicast group has received all data packets of the to-be-sent file, the method further includes:

sending a second master receiving device determining message to the second device, where the second master receiving device determining message is used to notify the second device that the second device has been selected as a master receiving device, and when a receiving acknowledgment message that carries a second data packet identifier and is sent by the second device is received, sending, to the current multicast group in a multicast manner according to the second data packet identifier, a data packet that is of the to-be-sent file and has not been received by the second device, where the second data packet identifier is used to indicate a data packet that the second device needs to receive next time, and the second data packet identifier is determined by the second device according to a data packet that is of the to-be-sent file and has been received by the second device; or

sending the ready request message to the current multicast group in a multicast manner, when the sending device receives a first ready message returned by a third device in the current multicast group, sending a third master receiving device determining message to the third device, where the third master receiving device determining message is used to notify the third device that the third device has been selected as a master receiving device, and when a receiving acknowledgment message that carries a third data packet identifier and is sent by the third device is received, sending, to the current multicast group in a multicast manner according to the third data packet identifier, a data packet that is of the to-be-sent file and has not been received by the third device, where the third data packet identifier is used to indicate a data packet that the third device needs to receive next time, and the third data packet identifier is determined by the third device according to a data packet that is of the to-be-sent file and has been received by the third device.

With reference to the second possible implementation manner of the first aspect, in a third possible implementation manner of the first aspect, when the sending device receives a first receiving acknowledgment message sent by the current master receiving device of the multicast group, and the first receiving acknowledgment message carries a fourth data packet identifier, it is determined that the current master receiving device of the multicast group has received all data packets of the to-be-sent file, where the fourth data packet identifier is used to indicate the last data packet of the to-be-sent file.

According to a second aspect, a file transfer method is provided, where the method includes:

in a process in which a sending device sends a data packet of a to-be-sent file to a device in a multicast group in a multicast manner, joining, by a second device the multicast group, where the multicast group includes at least one device;

receiving a first message sent by the sending device to the second device, where the first message carries at least a file name and block quantity of the to-be-sent file and a first data packet identifier, the first data packet identifier is used to indicate a data packet to be transferred by the sending device, and the first message is used to notify the second device of information about the data packet to be transferred by the sending device; and

receiving, according to the first message, the data packet that is of the to-be-sent file and is to be transferred by the sending device.

With reference to the second aspect, in a first possible implementation manner of the second aspect, after the receiving a first message sent by the sending device to the second device, the method further includes:

sending, by the second device, a ready message to the sending device.

With reference to the second aspect, in a second possible implementation manner of the second aspect, the method further includes: receiving, by the second device, a second master receiving device determining message, where the second master receiving device determining message is sent by the sending device to the second device when a current master receiving device of the multicast group has received all data packets of the to-be-sent file, and the second master receiving device determining message is used to notify the second device that the second device has been selected as a master receiving device;

sending, by the second device to the sending device according to a data packet that is of the to-be-sent file and has been received by the second device, a receiving acknowledgment message that carries a second data packet identifier, where the second data packet identifier is used to indicate a data packet that the second device needs to receive next time, so that the sending device sends, to the current multicast group in a multicast manner according to the second data packet identifier, a data packet that is of the to-be-sent file, and has not been received by the second device; and

receiving the data packet that is of the to-be-sent file, is sent by the sending device, and has not been received by the second device.

According to a third aspect, a file transfer apparatus is provided, where the apparatus includes: a sending module and a receiving module, where

the sending module is configured to send a ready request message to a multicast group in a multicast manner, where the ready request message carries at least a file name and block quantity of a to-be-sent file, and the multicast group includes at least one device;

the receiving module is configured to receive a ready message returned by a device in the multicast group;

the sending module is further configured to: when the receiving module receives a first ready message returned by a first device in the multicast group, send a first master receiving device determining message to the first device, where the first master receiving device determining message is used to notify the first device that the first device has been selected as a master receiving device, and send a data packet of the to-be-sent file to the multicast group in a multicast manner; and

the sending module is further configured to: when a second device newly joins the multicast group, send a first message to the second device, where the first message carries at least the file name and block quantity of the to-be-sent file and a first data packet identifier, the first data packet identifier is used to indicate a data packet to be transferred by the sending device, the first message is used to notify the second device of information about the data packet to be transferred by the sending device, so that the second device receives, according to the first message, the data packet that is of the to-be-sent file and is to be transferred by the sending device.

With reference to the third aspect, in a first possible implementation manner of the third aspect, the receiving module is further configured to: after the sending module sends the first message to the second device, receive a ready message sent by the second device.

With reference to the third aspect, in a second possible implementation manner of the third aspect, the sending module is further configured to: when the current master receiving device of the multicast group has received all data packets of the to-be-sent file, send a second master receiving device determining message to the second device, where the second master receiving device determining message is used to notify the second device that the second device has been selected as a master receiving device;

the receiving module is further configured to receive a receiving acknowledgment message that carries a second data packet identifier and is sent by the second device; and

the sending module is further configured to: when the receiving module receives the receiving acknowledgment message that carries the second data packet identifier and is sent by the second device, send, to the current multicast group in a multicast manner according to the second data packet identifier, a data packet that is of the to-be-sent file and has not been received by the second device, where the second data packet identifier is used to indicate a data packet that the second device needs to receive next time, and the second data packet identifier is determined by the second device according to a data packet that is of the to-be-sent file and has been received by the second device;

or

the sending module is further configured to: when the current master receiving device of the multicast group has received all data packets of the to-be-sent file, send the ready request message to the current multicast group in a multicast manner;

the receiving module is further configured to receive a ready message sent by a device in the current multicast group;

the sending module is further configured to: when the receiving module receives a first ready message returned by a third device in the current multicast group, send a third master receiving device determining message to the third device, where the third master receiving device determining message is used to notify the third device that the third device has been selected as a master receiving device;

the receiving module is further configured to receive a receiving acknowledgment message that carries a third data packet identifier and is sent by the third device; and

the sending module is further configured to: when the receiving module receives the receiving acknowledgment message that carries the third data packet identifier and is sent by the third device, send, to the current multicast group in a multicast manner according to the third data packet identifier, a data packet that is of the to-be-sent file and has not been received by the third device, where the third data packet identifier is used to indicate a data packet that the third device needs to receive next time, and the third data packet identifier is determined by the third device according to a data packet that is of the to-be-sent file and has been received by the third device.

With reference to the second possible implementation manner of the third aspect, in a third possible implementation manner of the third aspect, the apparatus further includes a confirming module, configured to: when the receiving module receives a first receiving acknowledgment message sent by the current master receiving device of the multicast group, and the first receiving acknowledgment message carries a fourth data packet identifier, determine that the current master receiving device of the multicast group has received all data packets of the to-be-sent file, where the fourth data packet identifier is used to indicate the last data packet of the to-be-sent file.

According to a fourth aspect, a file transfer apparatus is provided, where the apparatus includes: a receiving module and a joining module, where

in a process in which a sending device sends a data packet of a to-be-sent file to a device in a multicast group in a multicast manner, the joining module is configured to join the multicast group, where the multicast group includes at least one device;

the receiving module is configured to receive a first message sent by the sending device to the apparatus, where the first message carries at least a file name and block quantity of the to-be-sent file and a first data packet identifier, the first data packet identifier is used to indicate a data packet to be transferred by the sending device, and the first message is used to notify the apparatus of information about the data packet to be transferred by the sending device; and

the receiving module is further configured to receive, according to the first message, the data packet that is of the to-be-sent file and is to be transferred by the sending device.

With reference to the fourth aspect, in a first possible implementation manner of the fourth aspect, the apparatus further includes a sending module, where the sending module is configured to: after the receiving module receives the first message sent by the sending device, send a ready message to the sending device.

With reference to the fourth aspect, in a second possible implementation manner of the fourth aspect, the receiving module is further configured to receive a second master receiving device determining message, where the second master receiving device determining message is sent by the sending device to the apparatus when a current master receiving device of the multicast group has received all data packets of the to-be-sent file, and the second master receiving device determining message is used to indicate that the apparatus has been selected as a master receiving device;

the sending module is further configured to: send, to the sending device according to a data packet that is of the to-be-sent file and has been received by the apparatus, a receiving acknowledgment message that carries a second data packet identifier, where the second data packet identifier is used to indicate a data packet that the apparatus needs to receive next time, so that the sending device sends, to the current multicast group in a multicast manner according to the second data packet identifier, a data packet that is of the to-be-sent file and has not been received by the apparatus; and

the receiving module is further configured to receive the data packet that is of the to-be-sent file, is sent by the sending device, and has not been received by the apparatus.

The technical solutions provided in the embodiments of the present invention bring the following beneficial effects:

When a new device joins a multicast group, the newly joined device is notified in time of information about a file that is currently being transferred, so that the newly joined device can learn in time content of the currently transferred file in an MFTP process that has been performed, and start receiving immediately, which improves transfer efficiency.

### BRIEF DESCRIPTION OF DRAWINGS

To describe the technical solutions in the embodiments of the present invention more clearly, the following briefly introduces the accompanying drawings required for describing the embodiments. Apparently, the accompanying drawings in the following description show merely some embodiments of the present invention, and a person of ordinary skill in the art may still derive other drawings from these accompanying drawings without creative efforts.

FIG. 1 is a flowchart of a file transfer method according to an embodiment of the present invention;

FIG. 2 is a flowchart of a file transfer method according to an embodiment of the present invention;

FIG. 3A and FIG. 3B are a flowchart of a file transfer method according to an embodiment of the present invention;

FIG. 4 is a schematic structural diagram of a file transfer apparatus according to an embodiment of the present invention;

FIG. 5 is a schematic structural diagram of a file transfer apparatus according to an embodiment of the present invention;

FIG. 6 is a schematic structural diagram of a device involved in an embodiment of the present invention; and

FIG. 7 is a schematic structural diagram of a device involved in an embodiment of the present invention.

### DESCRIPTION OF EMBODIMENTS

To make the objectives, technical solutions, and advantages of the present invention clearer, the following further describes the embodiments of the present invention in detail with reference to the accompanying drawings.

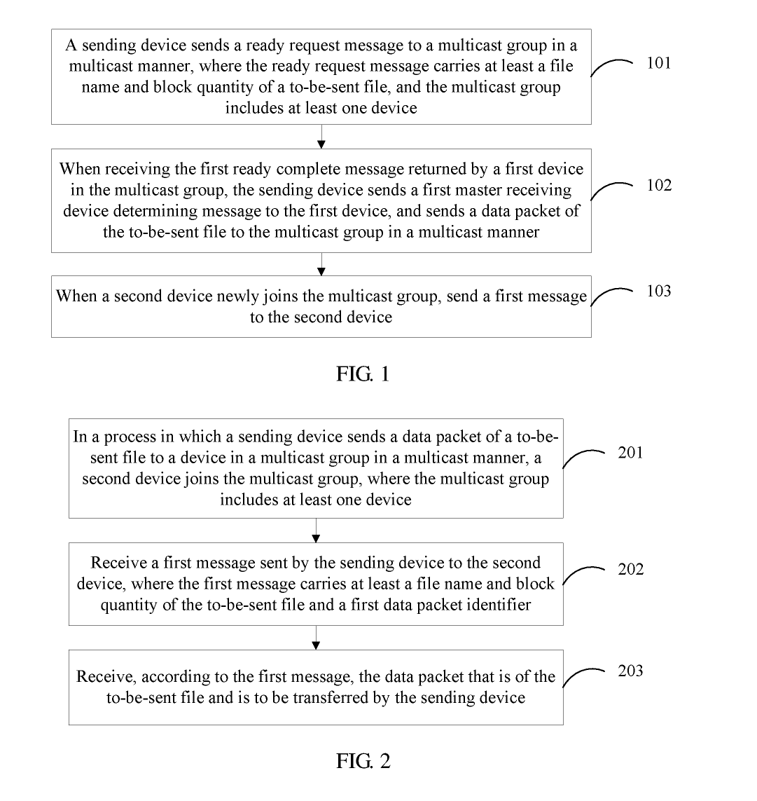

FIG. 1 is a flowchart of a file transfer method according to an embodiment of the present invention. Referring to FIG. 1, the method includes:

101. A sending device sends a ready request message to a multicast group in a multicast manner, where the ready request message carries at least a file name and block quantity of a to-be-sent file, and the multicast group includes at least one device.

102. When receiving a first ready message returned by a first device in the multicast group, the sending device sends a first master receiving device determining message to the first device, where the first master receiving device determining message is used to notify the first device that the first device has been selected as a master receiving device, and sends a data packet of the to-be-sent file to the multicast group in a multicast manner.

103. When a second device newly joins the multicast group, send a first message to the second device, where the first message carries at least the file name and block quantity of the to-be-sent file and a first data packet identifier, the first data packet identifier is used to indicate a data packet to be transferred by the sending device, and the first message is used to notify the second device of information about the data packet to be transferred by the sending device, so that the second device receives, according to the first message, the data packet that is of the to-be-sent file and is to be transferred by the sending device.

According to the method provided in this embodiment of the present invention, when a new device joins a multicast group, the newly joined device is notified in time of information about a file that is currently being transferred, so that the newly joined device can learn in time content of the currently transferred file in an MFTP process that has been performed, and start receiving immediately, which improves transfer efficiency.

FIG. 2 is a flowchart of a file transfer method according to an embodiment of the present invention. Referring to FIG. 2, the method includes the following steps:

201. In a process in which a sending device sends a data packet of a to-be-sent file to a device in a multicast group in a multicast manner, a second device joins the multicast group, where the multicast group includes at least one device.

202. Receive a first message sent by the sending device to the second device, where the first message carries at least a file name and block quantity of the to-be-sent file and a first data packet identifier, the first data packet identifier is used to indicate a data packet to be transferred by the sending device, and the first message is used to notify the second device of information about the data packet to be transferred by the sending device.

203. Receive, according to the first message, the data packet that is of the to-be-sent file and is to be transferred by the sending device.

According to the method provided in this embodiment of the present invention, when a new device joins a multicast group, the newly joined device is notified in time of information about a file that is currently being transferred, so that the newly joined device can learn in time content of the currently transferred file in an MFTP process that has been performed, and start receiving immediately, which improves transfer efficiency.

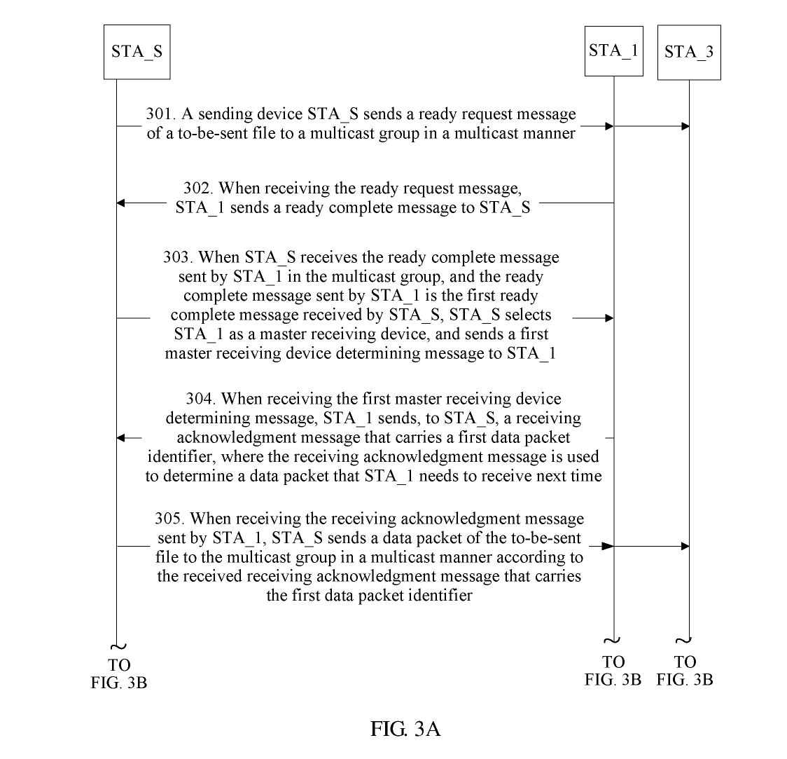

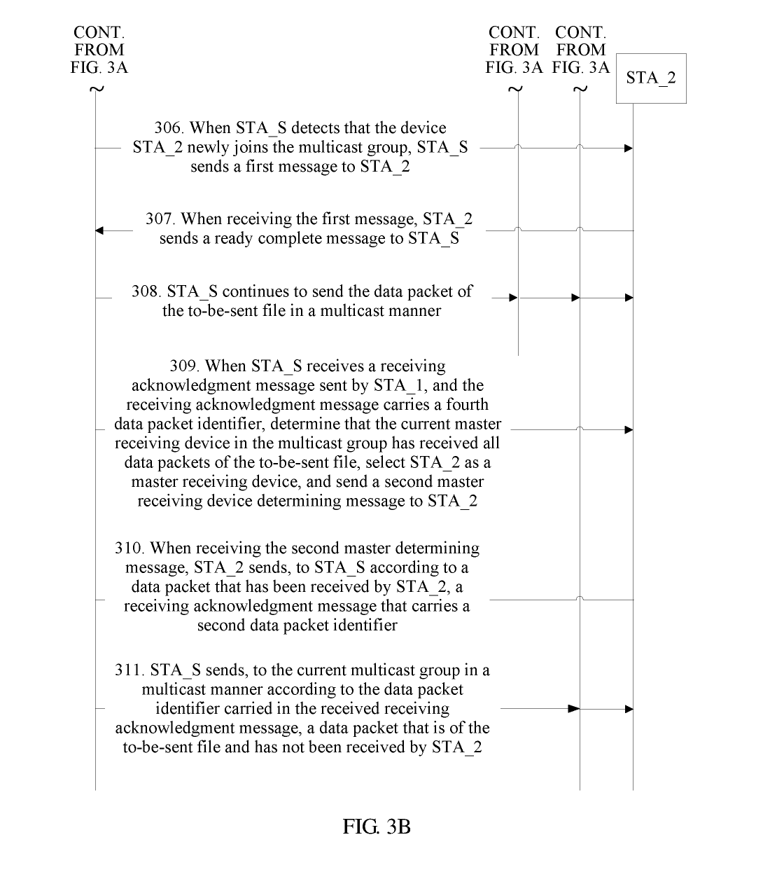

FIG. 3A and FIG. 3B are a flowchart of a file transfer method according to an embodiment of the present invention. An interaction body in this embodiment of the present invention is a sending device STA_S; receiving devices in a multicast group includes a first device STA_1 and a third device STA_3; and a newly joined second device is indicated by STA_2. Referring to FIG. 3A and FIG. 3B, the method includes the following steps:

301. The sending device STA_S sends a ready request message of a to-be-sent file to the multicast group in a multicast manner, where the ready request message carries at least a file name and block quantity of the to-be-sent file, and the multicast group includes at least one device.

Multiple devices in the multicast group establish IP layer connections with the sending device.

Optionally, the ready request message may be an RRQ, and in addition to carrying the file name and block quantity of the to-be-sent file, the ready request message may further carry a size of the file.

302. When receiving the ready request message, STA_1 sends a ready message to STA_S.

When STA_1 receives the ready request message, a user of STA_1 may choose whether to accept transfer of the to-be-sent file. When it is determined to accept transfer of the to-be-sent file, it may be determined by using a function key of STA_1, so that STA_1 sends the ready message to STA_S.

It should be noted that this embodiment of the present invention is described only by using an example in which STA_1 is a device that first feeds back the ready message. Therefore, in step 302, only a process in which STA_1 sends the ready message is described. In an actual scenario, for each receiving device in the multicast group, a process in which each receiving device sends a ready message is similar to that of step 302, and details are not described herein again.

303. When STA_S receives the ready message sent by STA_1 in the multicast group, and the ready message sent by STA_1 is the first ready message received by STA_S, STA_S selects STA_1 as a master receiving device, and sends a first master receiving device determining message to STA_1, where the first master receiving device determining message is used to notify STA_1 that STA_1 has been selected as a master receiving device.

Further, when STA_S further receives, after receiving the first ready message, a ready message sent by another receiving device such as STA_2, STA_S sends a non-master receiving device determining message to the another receiving device, so that when receiving the message, the another receiving device learns that the another receiving device itself is not a master receiving device, that is, when receiving a data packet sent by STA_S, the another receiving device does not need to return a receiving acknowledgment message.

It should be noted that a first master receiving device determining message, a second master receiving device determining message, and the like in step 303 and subsequent steps are only used to differentiate a determined master receiving device. In fact, specific formats, carried information, and the like of the first master receiving device determining message, the second master receiving device determining message, and the like may be the same, which is not limited in this embodiment of the present invention.

304. When receiving the first master receiving device determining message, STA_1 sends, to STA_S, a receiving acknowledgment message that carries a first data packet identifier, where the first data packet identifier is used to indicate a data packet to be transferred by the sending device, and the receiving acknowledgment message is used to determine a data packet that STA_1 needs to receive next time.

305. When receiving the receiving acknowledgment message sent by STA_1, STA_S sends a data packet of the to-be-sent file to the multicast group in a multicast manner according to the received receiving acknowledgment message that carries the first data packet identifier.

For the foregoing steps 303 to 305, the first master receiving device determining message is an MRQ (Master Request, master receiving device determining message), and the first master receiving device determining message is used to notify that the first device has been selected as a master receiving device. Each time receiving a data packet sent by STA_S in a multicast manner, the master receiving device needs to feed back a receiving acknowledgment message to STA_S, where the receiving acknowledgment message is used to determine a data packet identifier that the master receiving device needs to receive next time, so that STA_S continues to send a data packet according to a received data packet identifier. For example, if a data packet identifier that may be carried in the receiving acknowledgment message is (k-1), when STA_S receives (k-1), STA_S sends a data packet whose data packet identifier is k, where k is a positive integer. That is, if a data packet identifier carried in the receiving acknowledgment message is 3, a next data packet that STA_1 needs to receive is a data packet whose data packet identifier is 4.

The foregoing steps 303 to 305 is a process of sending the to-be-sent file in a form of a data packet when the sending device receives the first ready message returned by any receiving device in the multicast group.

306. When STA_S detects that the device STA_2 newly joins the multicast group, STA_S sends a first message to STA_2, where the first message carries at least the file name and block quantity of the to-be-sent file and a first data packet identifier, the first data packet identifier is used to indicate a data packet to be transferred by STA_S, and the first message is used to notify STA_2 of information about the data packet to be transferred by STA_S.

In addition to carrying the file name and block quantity of the to-be-sent file, the first message may further carry a size of the file. The first message is used to notify the newly joined device of a specific status of the file that is currently being transferred, so that the newly joined device can receive, based on current transfer, the file that is being transferred by the sending device. Certainly, the first message may also not carry the data packet identifier of the data packet to be transferred by STA_S, which is not specifically limited in this embodiment of the present invention. In addition, the data packet identifier used to indicate the data packet to be transferred by STA_S may be a data packet identifier of a data packet that is being transferred by STA_S, or may be a data packet identifier of a data packet to be transferred by STA_S. The receiving device may learn, by using a protocol between the sending device and the receiving device, that which data packet of the to-be-sent file is a data packet that is currently being transferred by the sending device, and may further learn that which data packet of the to-be-sent file is a data packet to be transferred by the sending device.

A manner in which the sending device detects that a new receiving device joins the multicast group includes any one of the following cases: (1) When the sending device is an initiation and management device of a local area network, the sending device has a Dynamic Host Configuration Protocol (DHCP, Dynamic Host Configuration Protocol) function, and is responsible for mapping of multicast addresses. Each device that newly joins the network needs to apply to the sending device for an IP address, and therefore when a new device applies to join the multicast group, the sending device can detect the newly joined device. (2) The sending device is located in a local area network, and when a new device joins the local area network, the sending device can obtain a message that the new device joins a multicast group at an IP layer, thereby detecting that the new device joins the multicast group. (3) A router is responsible for address mapping of the multicast group. When a newly joined device applies to the router to join the multicast group, the router updates an address mapping table of the multicast group and simultaneously notifies the sending device according to a beforehand setting, so that the sending device can detect the newly joined device. All the local area networks in these methods may be a wireless local area network. In fact, there may also be another implementation manner for the method for detecting a newly joined device, and details are not described again in this embodiment of the present invention.

307. When receiving the first message, STA_2 sends a ready message to STA_S.

The ready message is used to notify STA_S that STA_2 has started a file receiving process. In this case, after joining the multicast group and sending the ready message, STA_2 receives, starting from a data packet that is currently being sent by STA_S, a data packet sent by STA_S.

308. STA_S continues to send the data packet of the to-be-sent file in a multicast manner.

Step 308 is similar to step 305, and is a process in which STA_S continues to send the data packet of the to-be-sent file, and details are not described herein again.

309. When STA_S receives a receiving acknowledgment message sent by STA_1, and the receiving acknowledgment message carries a fourth data packet identifier, determine that the current master receiving device of the multicast group has received all data packets of the to-be-sent file, where the fourth data packet identifier is used to indicate the last data packet of the to-be-sent file, select STA_2 as a master receiving device, and send a second master receiving device determining message to STA_2, where the second master receiving device determining message is used to notify STA_2 that STA_2 has been selected as a master receiving device.

When STA_S receives the receiving acknowledgment message sent by STA_1, and the receiving acknowledgment message carries a data packet identifier of the last data packet of the to-be-sent file, it is determined that STA_1 has received all the data packets of the to-be-sent file, that is, file transfer to STA_1 is completed, and STA_2 that newly joins the multicast group is selected as a master receiving device.

It should be noted that this embodiment of the present invention is described only by using an example in which the newly joined device is selected, after it is determined that the current master receiving device of the multicast group has received all the data packets of the to-be-sent file, as a master receiving device to continue sending. In fact, after it is determined that the current master receiving device of the multicast group has received all the data packets of the to-be-sent file, the sending device may further send the ready request message again in a multicast manner, so that a receiving device that receives the ready request message returns a ready message, and a receiving device that first returns the ready message is selected as a master receiving device. That is, step 309 may be replaced by the following step: Send the ready request message to the current multicast group in a multicast manner, when the sending device receives a first ready message returned by a third device (for example, STA_3) in the current multicast group, send a third master receiving device determining message to the third device, where the third master receiving device determining message is used to notify the third device that the third device has been selected as a master receiving device, and when a receiving acknowledgment message that carries a third data packet identifier and is sent by the third device is received, send, to the current multicast group in a multicast manner according to the third data packet identifier, a data packet that is of the to-be-sent file and has not been received by the third device, where the third data packet identifier is used to indicate a data packet that the third device needs to receive next time, and the third data packet identifier is determined by the third device according to a data packet that is of the to-be-sent file and has been received by the third device. It should be noted that there may be one or more third data packet identifiers, that is, the third device STA_3 may notify STA_S at a time of multiple data packets that have not been received by STA_3, or may notify STA_S for multiple times of data packets that have not been received by STA_3, which is not specifically limited in this embodiment of the present invention.

310. When receiving the second master receiving device determining message, STA_2 sends, to STA_S according to a data packet that has been received by STA_2, a receiving acknowledgment message that carries a second data packet identifier, where the second data packet identifier is used to indicate a data packet that STA_2 needs to receive next time, and the second data packet identifier is determined by STA_2 according to the data packet that is of the to-be-sent file and has been received by STA_2.

It should be noted that there may be one or more second data packet identifiers, that is, the second device STA_2 may notify STA_S at a time of multiple data packets that have not been received by STA_2, or may notify STA_S for multiple times of data packets that have not been received by STA_2, which is not specifically limited in this embodiment of the present invention.

After steps 307 and 308, STA_2 has received some data packets of the to-be-sent file. In order to receive all data packets of the to-be-sent file, STA_2 sends the receiving acknowledgment message to STA_S according to the received data packets, where the receiving acknowledgment message is used to determine a data packet that STA_2 needs to receive next time. It should be noted that because a data packet may be lost in a transfer process, in step 310, the receiving acknowledgment message may be sent according to a requirement, so as to acquire a data packet that has not been received by STA_2.

For example, the to-be-sent file is divided into ten data packets. When STA_2 has currently received data packets whose data packet identifiers are 1, 4, and 5, a receiving acknowledgment message sent by STA_2 may carry any data packet identifier of 1, 2, and 5 to 9, that is, the data packet identifiers are respectively used to request to receive data packets whose identifiers are 2, 3, and 6 to 10.

311. STA_S sends, to the current multicast group in a multicast manner according to the data packet identifier carried in the received receiving acknowledgment message, a data packet that is of the to-be-sent file and has not been received by STA_2.

The multicast group at this moment is a multicast group that excludes the original receiving device STA_1 and in which the new device STA_2 joins.

Steps 306 to 311 are a transfer process when it is detected that a new device joins the multicast group. When it is determined that STA_2 has received all the data packets of the to-be-sent file, if there is no newly joined device currently, a master receiving device continues to be selected and perform file transfer according to a process of steps 301 to 305; if there is a newly joined device, steps 306 to 311 continue to be performed, and details are not described again in this embodiment of the present invention.

It should be noted that the first data packet identifier, the second data packet identifier, the third data packet identifier, and the fourth data packet identifier involved in the foregoing process are only used to differentiate data packet identifiers of different stages, but not differentiate types and the like of data packet identifiers.

According to the method provided in this embodiment of the present invention, by changing the existing MFTP protocol, when a new device joins a multicast group, the newly joined device is notified in time of information about a file that is currently being transferred, so that the newly joined device can learn in time content of the currently transferred file in an MFTP process that has been performed, and start receiving immediately, which improves transfer efficiency.

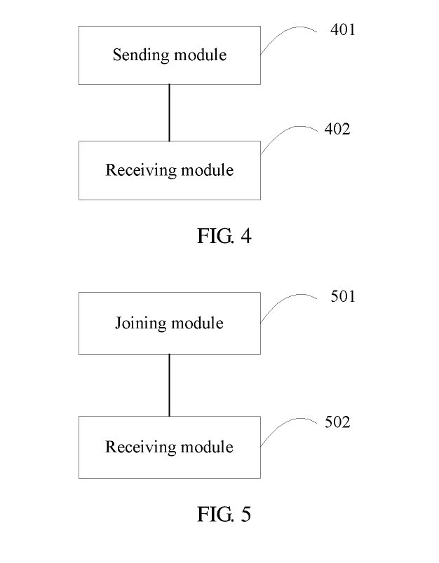

FIG. 4 is a schematic structural diagram of a file transfer apparatus according to an embodiment of the present invention. Referring to FIG. 4, the apparatus includes: a sending module 401 and a receiving module 402, where the sending module 401 is connected to the receiving module 402; the sending module 401 is configured to send a ready request message to a multicast group in a multicast manner, where the ready request message carries at least a file name and block quantity of a to-be-sent file, and the multicast group includes at least one device; the receiving module 402 is configured to receive a ready message returned by a device in the multicast group; the sending module 401 is further configured to: when the receiving module 402 receives a first ready message returned by a first device in the multicast group, send a first master receiving device determining message to the first device, where the first master receiving device determining message is used to notify the first device that the first device has been selected as a master receiving device, and send a data packet of the to-be-sent file to the multicast group in a multicast manner; and the sending module 401 is further configured to: when a second device newly joins the multicast group, send a first message to the second device, where the first message carries at least the file name and block quantity of the to-be-sent file and a first data packet identifier, the first data packet identifier is used to indicate a data packet to be transferred by the sending device, the first message is used to notify the second device of information about the data packet to be transferred by the sending device, so that the second device receives, according to the first message, the data packet that is of the to-be-sent file and is to be transferred by the sending device.

Optionally, the receiving module 402 is further configured to: after the sending module 401 sends the first message to the second device, receive a ready message sent by the second device.

Optionally, the sending module 401 is further configured to: when the current master receiving device of the multicast group has received all data packets of the to-be-sent file, send a second master receiving device determining message to the second device, where the second master receiving device determining message is used to notify the second device that the second device has been selected as a master receiving device;

the receiving module 402 is further configured to receive a receiving acknowledgment message that carries a second data packet identifier and is sent by the second device; and

the sending module 401 is further configured to: when the receiving module 402 receives the receiving acknowledgment message that carries the second data packet identifier and is sent by the second device, send, to the current multicast group in a multicast manner according to the second data packet identifier, a data packet that is of the to-be-sent file and has not been received by the second device, where the second data packet identifier is used to indicate a data packet that the second device needs to receive next time, and the second data packet identifier is determined by the second device according to a data packet that is of the to-be-sent file and has been received by the second device;

or

the sending module 401 is further configured to: when the current master receiving device of the multicast group has received all data packets of the to-be-sent file, send the ready request message to the current multicast group in a multicast manner;

the receiving module 402 is further configured to receive a ready message sent by a device in the current multicast group;

the sending module 401 is further configured to: when the receiving module 402 receives a first ready message returned by a third device in the current multicast group, send a third master receiving device determining message to the third device, where the third master receiving device determining message is used to notify the third device that the third device has been selected as a master receiving device;

the receiving module 402 is further configured to receive a receiving acknowledgment message that carries a third data packet identifier and is sent by the third device; and

the sending module 401 is further configured to: when the receiving module 402 receives the receiving acknowledgment message that carries the third data packet identifier and is sent by the third device, send, to the current multicast group in a multicast manner according to the third data packet identifier, a data packet that is of the to-be-sent file and has not been received by the third device, where the third data packet identifier is used to indicate a data packet that the third device needs to receive next time, and the third data packet identifier is determined by the third device according to a data packet that is of the to-be-sent file and has been received by the third device.

Optionally, the apparatus further includes a confirming module, configured to: when the receiving module 402 receives a first receiving acknowledgment message sent by the current master receiving device of the multicast group, and the first receiving acknowledgment message carries a fourth data packet identifier, determine that the current master receiving device of the multicast group has received all data packets of the to-be-sent file, where the fourth data packet identifier is used to indicate the last data packet of the to-be-sent file.

FIG. 5 is a schematic structural diagram of a file transfer apparatus according to an embodiment of the present invention. Referring to FIG. 5, the apparatus includes a joining module 501 and a receiving module 502, where the joining module 501 is connected to the receiving module 502; in a process in which a sending device sends a data packet of a to-be-sent file to a device in a multicast group in a multicast manner, the joining module 501 is configured to join the multicast group, where the multicast group includes at least one device; the receiving module 502 is configured to receive a first message sent by the sending device to the apparatus, where the first message carries at least a file name and block quantity of the to-be-sent file and a first data packet identifier, the first data packet identifier is used to indicate a data packet to be transferred by the sending device, and the first message is used to notify the apparatus of information about the data packet to be transferred by the sending device; and the receiving module 502 is further configured to receive, according to the first message, the data packet that is of the to-be-sent file and is to be transferred by the sending device.

Optionally, the apparatus further includes a sending module, configured to: after the receiving module receives the first message sent by the sending device, send a ready message to the sending device.

Optionally, the receiving module 502 is further configured to receive a second master receiving device determining message, where the second master receiving device determining message is sent by the sending device to the apparatus when a current master receiving device of the multicast group has received all data packets of the to-be-sent file, and the second master receiving device determining message is used to indicate that the apparatus has been selected as a master receiving device;

the sending module 503 is further configured to: send, to the sending device according to a data packet that is of the to-be-sent file and has been received by the apparatus, a receiving acknowledgment message that carries a second data packet identifier, where the second data packet identifier is used to indicate a data packet that the apparatus needs to receive next time, so that the sending device sends, to the current multicast group in a multicast manner according to the second data packet identifier, a data packet that is of the to-be-sent file and has not been received by the apparatus; and

the receiving module 502 is further configured to receive the data packet that is of the to-be-sent file, is sent by the sending device, and has not been received by the apparatus.

It should be noted that, during file transfer performed by the file transfer apparatus provided in the foregoing embodiments, description is provided only by using division of the foregoing functional modules as an example. In an actual application, the forgoing functions may be allocated to different functional modules for completion according to requirements, that is, an internal structure of the device is divided into different functional modules, so as to complete all or some of the functions described above. In addition, the file transfer apparatus provided in the foregoing embodiments belongs to a same concept as the embodiments of the file transfer method. For a specific implementation process of the file transfer apparatus, refer to the method embodiments, and details are not described herein again.

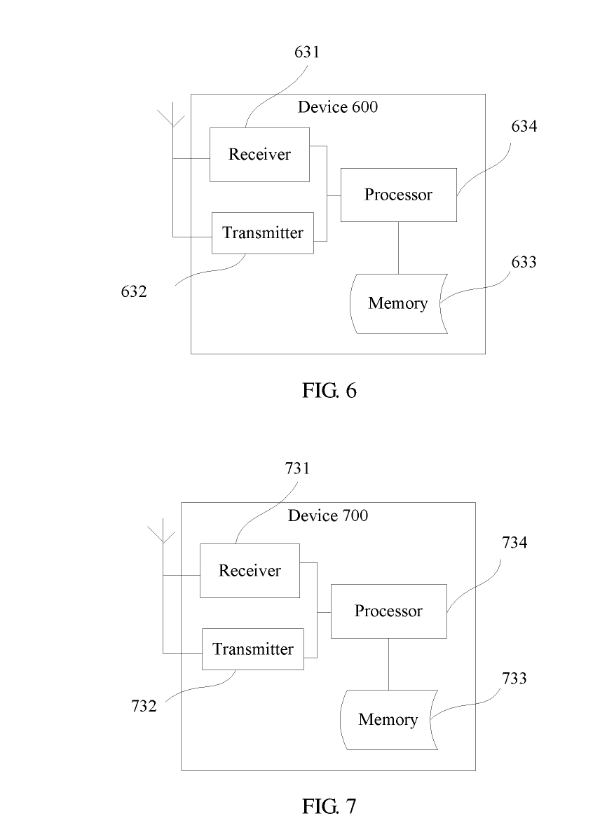

FIG. 6 is a schematic structural diagram of a device according to an embodiment of the present invention. As shown in FIG. 6, the device 600 includes: a transmitter 632, a receiver 631, a memory 633, and a processor 634 separately connected to the transmitter 632, the receiver 631, and the memory 633.

The memory 633 is configured to store executable program code, where the program code includes a computer operation instruction. The memory 633 may include a high-speed RAM memory, and may further include a non-volatile memory (non-volatile memory), for example, at least one disk memory.

The processor 634 may be a central processing unit (Central Processing Unit, CPU for short), or an application-specific integrated circuit (Application Specific Integrated Circuit, ASIC for short), or may be configured as one or more integrated circuits that implement the embodiments of the present invention.

The processor 634 is configured to execute the executable program code stored in the memory 633, such as a computer program, so as to run a program corresponding to the executable code.

The transmitter 632 sends a ready request message to a multicast group in a multicast manner, where the ready request message carries at least a file name and block quantity of a to-be-sent file, and the multicast group includes at least one device; when the receiver 631 receives a first ready message returned by a first device in the multicast group, the transmitter 632 sends a first master receiving device determining message to the first device, where the first master receiving device determining message is used to notify the first device that the first device has been selected as a master receiving device, and the transmitter 632 sends a data packet of the to-be-sent file to the multicast group in a multicast manner; and when a second device newly joins the multicast group, the transmitter 632 sends a first message to the second device, where the first message carries at least the file name and block quantity of the to-be-sent file and a first data packet identifier, the first data packet identifier is used to indicate a data packet to be transferred by the sending device, the first message is used to notify the second device of information about the data packet to be transferred by the sending device, so that the second device receives, according to the first message, the data packet that is of the to-be-sent file and is to be transferred by the sending device.

For a function implemented by the device, reference may be made to a function implemented by a sending device in the foregoing method embodiments.

FIG. 7 is a schematic structural diagram of a device according to an embodiment of the present invention. As shown in FIG. 7, the device 700 includes: a transmitter 732, a receiver 731, a memory 733, and a processor 734 separately connected to the transmitter 732, the receiver 731, and the memory 733.

The memory 733 is configured to store executable program code, where the program code includes a computer operation instruction. The memory 733 may include a high-speed RAM memory, and may further include a non-volatile memory (non-volatile memory), for example, at least one disk memory.

The processor 734 may be a central processing unit (Central Processing Unit, CPU for short), or an application-specific integrated circuit (Application Specific Integrated Circuit, ASIC for short), or may be configured as one or more integrated circuits that implement the embodiments of the present invention.

The processor 734 is configured to execute the executable program code stored in the memory 733, such as a computer program, so as to run a program corresponding to the executable code.

In a process in which a sending device sends a data packet of a to-be-sent file to a device in a multicast group in a multicast manner, the device 700 joins the multicast group, where the multicast group includes at least one device; the receiver 731 is configured to receive a first message sent by the sending device to the apparatus, where the first message carries at least a file name and block quantity of the to-be-sent file and a first data packet identifier, the first data packet identifier is used to indicate a data packet to be transferred by the sending device, and the first message is used to notify the second device of information about the data packet to be transferred by the sending device; and the receiver 731 is further configured to receive, according to the first message, the data packet that is of the to-be-sent file and is to be transferred by the sending device.

For a function implemented by the device, reference may be made to a function implemented by a second device in the foregoing method embodiments.

All the foregoing optional technical solutions may be combined in any manner to form an optional embodiment of the present invention, and details are not described herein again.

It should be noted that “first”, “second”, and the like in the embodiments of the present invention are all for differentiation between each other and have no another specific meaning.

A person of ordinary skill in the art may understand that all or some of the steps of the embodiments may be implemented by hardware or a program instructing related hardware. The program may be stored in a computer-readable storage medium. The storage medium may include: a read-only memory, a magnetic disk, or an optical disc.

The foregoing descriptions are merely exemplary embodiments of the present invention, but are not intended to limit the present invention. Any modification, equivalent replacement, and improvement made without departing from the spirit and principle of the present invention shall fall within the protection scope of the present invention.

What is claimed is:

1. A file transfer method, wherein the method comprises:
sending, by a sending device, a ready request message to a multicast group in a multicast manner, wherein the ready request message carries at least a file name and block quantity of a to-be-sent file, and the multicast group comprises at least one device;
when receiving a first ready message returned by a first device in the multicast group, sending, by the sending device, a first master receiving device determining message to the first device, wherein the first master receiving device determining message is used to notify the first device that the first device has been selected as a master receiving device, and sending a data packet of the to-be-sent file to the multicast group in a multicast manner; and
sending a first message to a second device when the second device newly joins the multicast group, wherein the first message carries at least the file name and block quantity of the to-be-sent file and a first data packet identifier, the first data packet identifier is used to indicate a data packet to be transferred by the sending device, and the first message is used to notify the second device of information about the data packet to be transferred by the sending device, so that the second device receives, according to the first message, the data packet that is of the to-be-sent file and is to be transferred by the sending device.

2. The method according to claim 1, wherein after the sending a first message to a second device when the second device newly joins the multicast group, the method further comprises:
receiving a ready message sent by the second device.

3. The method according to claim 1, wherein after the sending a first message to a second device, so that the second device receives, according to the first message, the data packet that is of the to-be-sent file and is to be transferred by the sending device, and when the current master receiving device of the multicast group has received all data packets of the to-be-sent file, the method further comprises:
sending a second master receiving device determining message to the second device, wherein the second master receiving device determining message is used to notify the second device that the second device has been selected as a master receiving device, and when a receiving acknowledgment message that carries a second data packet identifier and is sent by the second device is received, sending, to the current multicast group in a multicast manner according to the second data packet identifier, a data packet that is of the to-be-sent file and has not been received by the second device, wherein the second data packet identifier is used to indicate a data packet that the second device needs to receive next time, and the second data packet identifier is determined by the second device according to a data packet that is of the to-be-sent file and has been received by the second device; or
sending the ready request message to the current multicast group in a multicast manner, when the sending device receives a first ready message returned by a third device in the current multicast group, sending a third master receiving device determining message to the third device, wherein the third master receiving device determining message is used to notify the third device that the third device has been selected as a master receiving device, and when a receiving acknowledgment message that carries a third data packet identifier and is sent by the third device is received, sending, to the current multicast group in a multicast manner according to the third data packet identifier, a data packet that is of the to-be-sent file and has not been received by the third device, wherein the third data packet identifier is used to indicate a data packet that the third device needs to receive next time, and the third data packet identifier is determined by the third device according to a data packet that is of the to-be-sent file and has been received by the third device.

4. The method according to claim 3, wherein when the sending device receives a first receiving acknowledgment message sent by the current master receiving device of the multicast group, and the first receiving acknowledgment message carries a fourth data packet identifier, it is determined that the current master receiving device of the multicast group has received all data packets of the to-be-sent file, wherein the fourth data packet identifier is used to indicate the last data packet of the to-be-sent file.

5. A file transfer method, wherein the method comprises:
in a process in which a sending device sends a data packet of a to-be-sent file to a device in a multicast group in a multicast manner, joining, by a second device the multicast group, wherein the multicast group comprises at least one device;
receiving a first message sent by the sending device to the second device, wherein the first message carries at least a file name and block quantity of the to-be-sent file and a first data packet identifier, the first data packet identifier is used to indicate a data packet to be transferred by the sending device, and the first message is used to notify the second device of information about the data packet to be transferred by the sending device; and
receiving, according to the first message, the data packet that is of the to-be-sent file and is to be transferred by the sending device.

6. The method according to claim 5, wherein after the receiving a first message sent by the sending device to the second device, the method further comprises:
sending, by the second device, a ready message to the sending device.

7. The method according to claim 5, wherein the method further comprises:
receiving, by the second device, a second master receiving device determining message, wherein the second master receiving device determining message is sent by the sending device to the second device when a current master receiving device of the multicast group has received all data packets of the to-be-sent file, and the second master receiving device determining message is used to notify the second device that the second device has been selected as a master receiving device;
sending, by the second device to the sending device according to a data packet that is of the to-be-sent file and has been received by the second device, a receiving acknowledgment message that carries a second data packet identifier, wherein the second data packet identifier is used to indicate a data packet that the second device needs to receive next time, so that the sending device sends, to the current multicast group in a multicast manner according to the second data packet identifier, a data packet that is of the to-be-sent file and has not been received by the second device; and
receiving the data packet that is of the to-be-sent file, is sent by the sending device, and has not been received by the second device.

8. A file transfer apparatus, wherein the apparatus comprises: a sending module and a receiving module, wherein
the sending module is configured to send a ready request message to a multicast group in a multicast manner, wherein the ready request message carries at least a file name and block quantity of a to-be-sent file, and the multicast group comprises at least one device;
the receiving module is configured to receive a ready message returned by a device in the multicast group;
the sending module is further configured to: when the receiving module receives a first ready message returned by a first device in the multicast group, send a first master receiving device determining message to the first device, wherein the first master receiving device determining message is used to notify the first device that the first device has been selected as a master receiving device, and send a data packet of the to-be-sent file to the multicast group in a multicast manner; and
the sending module is further configured to: when a second device newly joins the multicast group, send a first message to the second device, wherein the first message carries at least the file name and block quantity of the to-be-sent file and a first data packet identifier, the first data packet identifier is used to indicate a data packet to be transferred by the sending device, the first message is used to notify the second device of information about the data packet to be transferred by the sending device, so that the second device receives, according to the first message, the data packet that is of the to-be-sent file and is to be transferred by the sending device.

9. The apparatus according to claim 8, wherein the receiving module is further configured to: after the sending module sends the first message to the second device, receive a ready message sent by the second device.

10. The apparatus according to claim 8, wherein:
the sending module is further configured to: when the current master receiving device of the multicast group has received all data packets of the to-be-sent file, send a second master receiving device determining message to the second device, wherein the second master receiving device determining message is used to notify the second device that the second device has been selected as a master receiving device;
the receiving module is further configured to receive a receiving acknowledgment message that carries a second data packet identifier and is sent by the second device; and
the sending module is further configured to: when the receiving module receives the receiving acknowledgment message that carries the second data packet identifier and is sent by the second device, send, to the current multicast group in a multicast manner according to the second data packet identifier, a data packet that is of the to-be-sent file and has not been received by the second device, wherein the second data packet identifier is used to indicate a data packet that the second device needs to receive next time, and the second data packet identifier is determined by the second device according to a data packet that is of the to-be-sent file and has been received by the second device; or
the sending module is further configured to: when the current master receiving device of the multicast group has received all data packets of the to-be-sent file, send the ready request message to the current multicast group in a multicast manner;
the receiving module is further configured to receive a ready message sent by a device in the current multicast group;
the sending module is further configured to: when the receiving module receives a first ready message returned by a third device in the current multicast group, send a third master receiving device determining message to the third device, wherein the third master receiving device determining message is used to notify the third device that the third device has been selected as a master receiving device;
the receiving module is further configured to receive a receiving acknowledgment message that carries a third data packet identifier and is sent by the third device; and
the sending module is further configured to: when the receiving module receives the receiving acknowledgment message that carries the third data packet identifier and is sent by the third device, send, to the current multicast group in a multicast manner according to the third data packet identifier, a data packet that is of the to-be-sent file and has not been received by the third device, wherein the third data packet identifier is used to indicate a data packet that the third device needs to receive next time, and the third data packet identifier is determined by the third device according to a data packet that is of the to-be-sent file and has been received by the third device.

11. The apparatus according to claim 10, wherein the apparatus further comprises a confirming module, configured to: when the receiving module receives a first receiving acknowledgment message sent by the current master receiving device of the multicast group, and the first receiving acknowledgment message carries a fourth data packet identifier, determine that the current master receiving device of the multicast group has received all data packets of the to-be-sent file, wherein the fourth data packet identifier is used to indicate the last data packet of the to-be-sent file.

12. A file transfer apparatus, wherein the apparatus comprises: a receiving module and a joining module, wherein
in a process in which a sending device sends a data packet of a to-be-sent file to a device in a multicast group in a multicast manner, the joining module is configured to join the multicast group, wherein the multicast group comprises at least one device;
the receiving module is configured to receive a first message sent by the sending device to the apparatus, wherein the first message carries at least a file name and block quantity of the to-be-sent file and a first data packet identifier, the first data packet identifier is used to indicate a data packet to be transferred by the sending device, and the first message is used to notify the apparatus of information about the data packet to be transferred by the sending device; and
the receiving module is further configured to receive, according to the first message, the data packet that is of the to-be-sent file and is to be transferred by the sending device.

13. The apparatus according to claim 12, wherein the apparatus further comprises a sending module, configured to: after the receiving module receives the first message sent by the sending device, send a ready message to the sending device.

14. The apparatus according to claim 12, wherein the receiving module is further configured to receive a second master receiving device determining message, wherein the second master receiving device determining message is sent by the sending device to the apparatus when a current master receiving device of the multicast group has received all data packets of the to-be-sent file, and the second master receiving device determining message is used to indicate that the apparatus has been selected as a master receiving device;
the sending module is further configured to: send, to the sending device according to a data packet that is of the to-be-sent file and has been received by the apparatus, a receiving acknowledgment message that carries a second data packet identifier, wherein the second data packet identifier is used to indicate a data packet that the apparatus needs to receive next time, so that the sending device sends, to the current multicast group in a multicast manner according to the second data packet identifier, a data packet that is of the to-be-sent file and has not been received by the apparatus; and
the receiving module is further configured to receive the data packet that is of the to-be-sent file, is sent by the sending device, and has not been received by the apparatus.
